(19) United States
(12) Patent Application Publication
(10) Pub. No.: US 2005/0209732 A1
(43) Pub. Date: Sep. 22, 2005

(54) Decision support system for supply chain management

(76) Inventors: Srinivasaragavan Audimoolam, Irvine, CA (US); Rick Dutta, Tustin, CA (US)

Correspondence Address: STRADLING YOCCA CARLSON & RAUTH;SUITE 1600, 660 NEWPORT CENTER DRIVE, P.O. BOX 7680, NEWPORT BEACH, CA, 92660, US

(21) Appl. No.: 10/440,394

(22) Filed: May 16, 2003

Related U.S. Application Data
(60) Provisional application No. 60/466,218, filed on Apr. 28, 2003.

(51) Int. Cl. G06G 1/14

(52) U.S. Cl. 700/216; 705/22

(57) ABSTRACT

A decision support system for supply chain management is disclosed. In one embodiment, an organizational structure of an enterprise value chain is mock-constructed as a framework model and solutions are logically distributed through the organization in accordance with the model. Product management, demand management and inventory management are performed on an exception basis and these processes are implemented incrementally and organizationally such that enterprise activities may be tracked and monitored, by exception, at multiple levels of granularity. In a general aspect, the invention enables collaborative ordering, forecasting, inventory and replenishment management by implementing such systems through an enterprise organizational model.

### CROSS REFERENCE TO RELATED APPLICATIONS

This application claims priority to U.S. Provisional Patent Application No. 60/466,218, filed May 16, 2002, entitled “Decision Support System for Supply Chain Management,” the entire contents of which are hereby incorporated by reference in its entirety.

### BACKGROUND OF THE INVENTION

In a product manufacturing or product distribution setting, customer orders for various items need to be processed and satisfied within a particular period of time. For every product not available in finished goods, a product must be manufactured to suit. To manufacture the product, certain manufacturing resources, such as raw materials, machine or production line time, shift worker hours, and the like are required and used in a pre-determined sequence. To efficiently utilize the manufacturing resources of a manufacturing plant or factory, a manufacturer generally employs systems and methods for scheduling the use of different resources at different dates and times to keep the factory running at peak efficiency. Resource schedules allow the manufacturer to plan for having sufficient resources available.

In traditional manufacturing methods for producing goods, raw materials are ordered well in advance and kept in a stockroom as raw material inventory. Such manufacturing methods typically use a scheduled manufacturing technique in which products are scheduled to be created based upon a weekly or monthly planning schedule. Usually, these products are produced as subassemblies or fabricated parts that are scheduled based upon the weekly or monthly requirements for finished products. These subassemblies are then assembled into the final product to fill actual customer orders, or to be placed into finished goods inventory.

Once a fabricated part is scheduled to be produced, a work order is generated and the parts, required to manufacture the assembly, are obtained from a parts warehouse based upon a planned manufacturing start date and order quantity. Parts are often produced in the same manner as the final product. Thus, after being produced, subassemblies are stored until they are needed for a final assembly. Because of the length of time of each process, a large inventory of parts and finished goods is often required to satisfy an unanticipated or fluctuating demand. This type of scheduled manufacturing process, therefore, requires a large amount of space for inventory. Additionally, storing such large amounts of inventory results in additional costs related to loss and damage to raw materials, subassemblies and finished goods over time.

Computer software programs have been developed to efficiently accomplish many of the calculations used in manufacturing systems by materials planners in a manufacturing organization to schedule and track raw materials inventory, batch assemblies and fabricated parts. Typically, such computer software programs can calculate and determine, and even generate purchase orders, for obtaining the anticipated amount of raw materials required based on the planning schedule input by the materials planners. These computer software programs can also assist in the scheduling of manufacturing resources other than raw materials, such as the scheduling of manufacturing production lines and shift worker crews. Other scheduling methods have been developed to assist in the planning of the acquisition of raw materials required in the manufacturing processes that utilize manufacturing methodologies other than batch manufacturing methods. Computer scheduling systems that employ these scheduling methods are generally referred to as materials requirement planning (or MRP) systems and typically assume an infinite capacity of machinery, shift worker hours, and the like and merely determine the amount and type of raw materials that must be on hand, at particular dates and times, for a given manufacturing process with given forecasted or actual orders.

An improvement over typical MRP systems, termed manufacturing resource planning systems, may also be used to schedule and allocate all kinds of manufacturing resources. These systems generally also use customer orders in marketing forecasts in order to determine the quantity of manufacturing resources needed at any given time to produce anticipated customer orders. In manufacturing resource planning systems, the number of days that it takes to manufacture a product (from set-up to delivery) is termed the manufacturing lead time or pipeline. A long lead time, caused by a subassembly manufacturing process may make it difficult to react quickly to unanticipated customer orders. The lengthy process of long manufacturing lead times, queues for each subassembly, and frequent trips to the stockroom or warehouse to obtain materials or introduce long periods of delay between manufacturing steps, and thus a long period of time between the customer's order and the completion and shipment of that order. One of the more significant problems of these materials resource planning systems is that the production schedule is created well in advance and cannot be altered easily. Additionally, the computer software programs used in these processes generally lack the ability to easily adjust schedules when conditions change. If the manufacturing process is to become more flexible, the computer software used for scheduling should also become more flexible. In the typical materials resource planning system, however, the production quantity or total demand on resources, is manually set by a master scheduler and cannot easily be adjusted.

Therefore, prospective scheduling systems have been developed which identify where and when resource magnitude or timing constraints will be violated if a certain number of orders are received such that these violations may be resolved before they actually happen. However, relationships and constraints associated with products and processes must be accurately modeled in the systems if they are to predict future events with any degree of precision. Models can include process yield and probability factors, but cannot predict random events such as equipment failure, missing parts, or bad weather. However, random events must be considered and planned for in advance so that excess material, capacity stores and even alternative resources can be used to prevent bottlenecks and maintain productivity.

In any manufacturing environment, timely and precise resource plans and schedules are often a critical success factor. Material requirements planning systems enhanced with the above considerations, can be used to determine future material requirements and potential shortages due to changing conditions and unexpected events, including unanticipated customer orders. The result of a successfully implemented system would be to reduce inventory and minimize material disruptions. However, even these kinds of material requirements planning systems function well only with definite and planned requirements (i.e., manufacturing systems in which products are built to meet forecasted amounts rather than customer orders) and where design changes and changes in the manufacturing process are infrequent.

Many types of manufacturing management and inventory control systems exist in current usage. However, each of these systems views the process from the narrow viewpoint of each organization's objectives. For example, inventory control processes tend to determine when the inventory of an item is projected to be depleted and when to order goods to prevent such depletion. Similarly, a manufacturing resource planning system considers inventory as well as machine and material availability, but does not take into account the effect of a sales promotion that will deplete an inventory more quickly than originally projected. Conversely, a marketing department, in preparing a sales promotion will often not consider the effect that the promotion will have on another organization's availability, inventory and profit margin, but rather tends to focus on immediate sales goals.

Implicit in this particular analysis is the understanding that enterprise-wide organizations consist not only of high-level functional departments (manufacturing, planning, design, sales, marketing, and the like) but also of fine-grain structure within each functional department that must accommodate and collaborate with the fine-grain structure of each of the other departments in order that the enterprise-wide organization can function efficiently.

Compounding the issue is the realization that manufacturers produce products for sale to customers. In order for any product to reach a customer it must flow through a distribution system (termed a supply chain) that operates in accordance with resource (capacity) and inventory (materials) constraints that are quite as complex as those of a manufacturing organization. A supply chain can be viewed as a global network of suppliers, fabrication sites, assembly locations, distribution centers and customer locations through which components and products flow. The bill of materials for products and components may consist of multiple levels, meaning that raw components may be assembled into more complex components or subassemblies and the subassemblies further combine to create yet more complex subassemblies, and so on, until the final level bill of materials is brought together to manufacture an end product (i.e., finished goods).

A supply chain is driven by customer orders for finished products. This is true whether the customer is a final consumer or, indeed, a manufacturing operation placing an order for a particular raw material. In general, the times at which customer orders are received form a non-stationary stochastic process. The fact that the process is non-stationary may be due to limited product life cycles, seasonal variations in demand, and changing economic conditions, as well as artificially created economic changes due to marketing driven promotions, and the like. A request date is typically associated with each customer order, which corresponds to a date, or time period, by which the customer would like to receive the completed order. Likewise, a service level might be loosely defined as that fraction of customer orders which are received by their request dates or even as that fraction of customer queries which receive a timely response.

Asset managers of large manufacturing enterprises, such as those found in the computer, electronics, and automobile industries, typically oversee extremely large supply chains involving multiple products, each with complex multi-level bills of materials. These asset managers have the responsibility for determining the appropriate inventory levels, in the form of components and finished goods, to hold at each level of a supply chain in order to guarantee specified end customer service levels. Given the size and complexity of these supply chains, a common problem for these asset managers is not knowing how to quantify the tradeoff between service levels and the investment in inventory required to support those service levels. The problem is made more difficult by the fact that the supply chains these asset managers oversee are dynamic, and their products have short lifetimes, new products are introduced frequently, customer demand is erratic and non-stationary, and service level requirements may change over time on a customer-by-customer basis. The dynamic nature of complex supply chains means that the tradeoff between service level and inventory investment changes over time, implying that asset managers must continually reevaluate this tradeoff so that they can make informed and timely decisions about inventory levels and service targets.

Additionally, increased manufacturing flexibility, particularly in a factory that produces more than one product, creates a need for long-term resource planning strategies based on production capacity and anticipated product mix. Similar scheduling methods may be applied to control other business operations including production capacity, distribution, maintenance and transportation scheduling. Frequent adjustments to schedules may be required because small changes in requirements, status, products, processes or their constraints may result in dramatic changes to the requirements for many different resources.

Further, the entire foregoing discussion has been presented in the context of top-level planners within a particular organization initiating and implementing all of the noted planning strategies and systems. Although most top-level managers receive substantial input from the fine-grain structure within their organization, such information is typically requested only for the purpose of implementing a plan and not necessarily for the purpose of creating an organizational context for planning implementation. Present-day systems are unable to accommodate dynamic input from lower-level organizational members that functions to adaptively inform a materials resource planning system, a distribution system, transportation allocation system, or the like.

Accordingly, there is a need for an improved system and method for providing a framework for collaboration between various organizations within an enterprise, such as planning, manufacturing, sales, marketing, finance and logistics as well as for collaboration between the organization and customers and sales partners outside the organization. In such a system, and according to such a method, each business entity develops its own projection for customer needs, market demand, and the like, but each such projection results will be reached on a consensual basis. Collaborative demand, inventory and distribution planning allows for enables a single implementation system useful to the entire value chain constituents, through the capture, brokering and fulfillment of a customer order across the multiple divisions, organizations and enterprises in any particular value network.

### SUMMARY OF THE INVENTION

In accordance with the invention, a system and method for order-to-supply collaborative management is provided that substantially eliminates or reduces the disadvantages and problems associated with previously deployed demand, inventory and distribution systems.

In accordance with the invention, the organizational structure of an enterprise value chain is mock-constructed as a framework model and solutions are logically distributed through the organization in accordance with the model. Product management, demand management and inventory management are performed on an exception basis and these processes are implemented incrementally and organizationally such that enterprise activities may be tracked and monitored, by exception, at multiple levels of granularity. In a general aspect, the invention enables collaborative ordering, forecasting, inventory and replenishment management by implementing such systems through an enterprise organizational model.

In one aspect of the invention, the system is implemented by initially modeling an intra and inter enterprise organization. The organizational structure and key metrics are defined such as the organization's suppliers, distributors and customers, as well as the organization's products and services. Further, organizational dimensions include the internal hierarchical structure of the organization in sufficient detail so as to identify organizational segmentation, key employees and certain employee/manager relationships. Organizational dimensions further include key decision variables and measurement metrics, such as sales, revenue, inventory on hand, demand forecast, inventory turnover rates, and the like.

In a further aspect of the invention, organizational hierarchies are defined and roles and responsibilities are assigned to organizational hierarchical nodes based upon defined key decision variables and measurement metrics. The novel methodology further allocated roles and responsibilities based on identified authority domains such as product categorization, geographical location, and the like.

Further, and in accordance with an additional aspect of the invention, the novel system and method defines collaborative relationships, internally and externally, required to implement a particular planning or implementation process. Vertical collaboration is defined in terms of managerial relationships with employee/manager relationships defined by a previously defined organizational hierarchy. Horizontal collaboration is defined by peer-to-peer relationships, such as might be exemplified by the collaboration between a product design manager and a product test manager. External relationships with customers, suppliers and possibly partners, are also included with interface junction nodes defined between external collaborators and internal organizational elements functionally identified to interface with each external collaborator. Key decision variables and measurement metrics are defined for the interaction between organizational nodes so defined. Key decision variables and measurement metrics defined the relationship between vertical collaboration nodes, horizontal collaboration nodes and between internal and external collaboration nodes.

Necessarily, and in furtherance of practice of principles of the invention, business process templates are constructed for the plurality of roles and responsibilities defined in connection with a particular organization. Workflow charts, reports, data collection and distribution points, exception metrics and process alerts are defined in a manner particularly relevant to a specific organization's hierarchical structure and the organization's defined set of roles and responsibilities associated to particular nodes within that structure.

### DESCRIPTION OF THE DRAWINGS

These and other features, aspects and advantages of the present invention will be more fully understood when considered in connection with the following specification, appended claims and accompanying drawings, wherein:

FIG. 1 is a simplified, semi-schematic illustration of the components and key enterprises of an industry value chain, exemplified by the integrated circuit industry, suitable for implementation of the present invention;

FIG. 2 is a simplified, semi-schematic flow diagram illustrating a conventional solution environment, configured for the integrated circuit industry value chain depicted in FIG. 1;

FIG. 3 is a simplified block-level diagram of a platform architecture suitable for practice of principles of the invention;

FIG. 4 is a simplified business process flow diagram illustrating the functional definition of exemplary aspects of the invention;

FIG. 5 is an exemplary organizational relationship diagram of an organizational model in accordance with the invention;

FIG. 6 is a simplified collaborative forecasting flow diagram illustrating the functional definition of further exemplary aspects of the invention;

FIG. 7 is an exemplary relationship diagram of an exception management process model in accordance with the invention;

FIG. 8 shows an exemplary solution module flowchart generated using the decision support system; and

FIG. 9 shows an exemplary simplified flowchart of product dimensions as created with the decision system.

### DESCRIPTION OF THE INVENTION

In the contemporary business world, a user population enters volumes of data into transaction systems. These volumes of data then go into at least one planning system. Often, the volumes of data may be dispersed into a plurality of planning systems within an organization, shared with external suppliers or users, and/or both. The responses to the data may then be fed back into transactions systems for decision support. This process of sequentially accessing, transferring and moving data is very disjointed, heavily relying upon users to evaluate data through reports in order to make effective decisions. The decision support system disclosed herein can be characterized as a system and methodology for allowing companies to operate their entire business decision making processes on an exception basis, and to offer individual users the ability to characterize problems and address a large proportion of those decisions themselves. Further, the decision system automates the process of bringing problems to an appropriate individual; suggesting appropriate assistance for decision-making to resolve problems, and empowers companies to automate the decision making process. In one embodiment, the decision system permits the users to automate the decision making process across selected divisions or user-groups, the entire enterprise, internal suppliers or consultants, external suppliers and consultants, or any other interested parties within a value chain as defined by the user.

In one embodiment, the methodology exhibits explicit separation among organizational structure, the business process logic, supported software applications and any type of content datasource. Suitably, a solution includes a methodology for implementing organizational modeling, business process modeling, work flow management, and role-based user subscription, all on an exception basis.

Organizational modeling provides the ability to build an organizational foundation which reflects how people, resources, products, and partners are interacting together across the entire value chain, internally and externally. Based on a user's identified role within the organization, the user can subscribe to all reports, data, or information that allows them to reach the best possible decision in view of the scope and extent of the defined issue. Exception-based alerts are triggered and conveyed to a pre-selected set of users based on user-subscriptions to the various types of alerts that might comprise a particular business process.

Since business decisions are required to be made anytime, a robust workflow management solution is implemented whereby data is collected at every point through the process and maintained in a data store for dissemination to appropriate destinations at any level of business granularity via designed workflow ‘routes’. Workflows may be easily redesigned in accordance with changes made to the determined organizational structure.

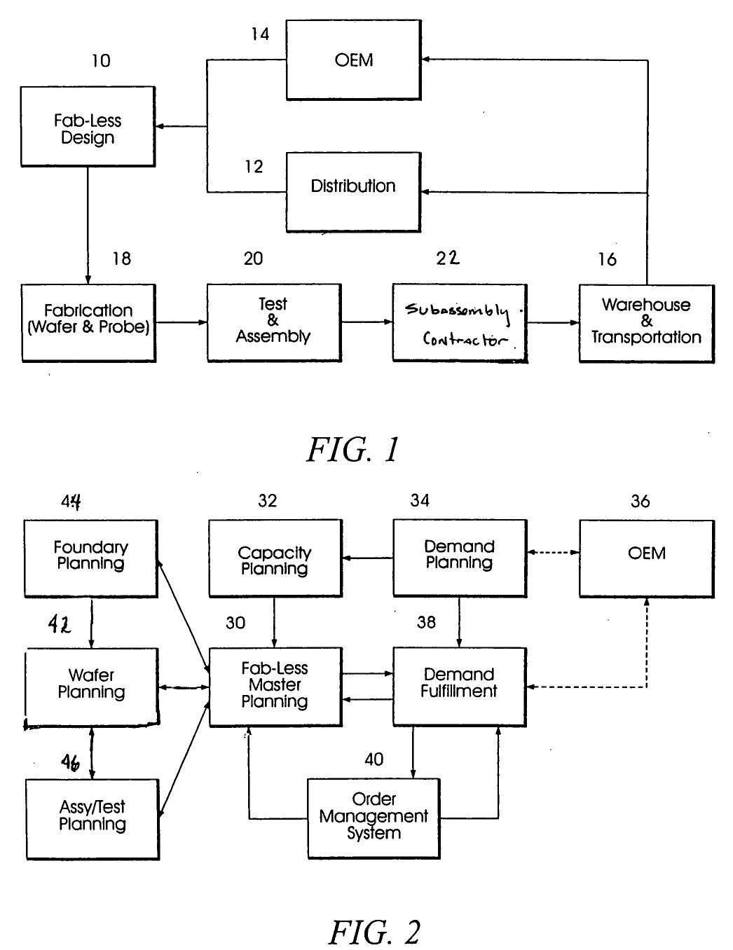

Prior to discussing the particular systems and methods comprising the decision support system, it will be valuable to describe the components of the decision support system and methodological steps in connection with an exemplary enterprise value chain such as the integrated circuit (or semi-conductor) industry. As can be seen in the exemplary embodiment of FIG. 1, the integrated circuit industry value chain is composed of multiple enterprises, typically separate and distinct from one another, that must collaboratively operate to bring a complete set of product offerings to a worldwide set of Original Equipment Manufactures (OEMs) and distributors. In today's design-driven environment, the central organization of the value chain is often a fab-less semi-conductor design facility 10 which functions as the product definition and design nexus of the value chain. Generally, a fab-less semiconductor company 10 engages in design of integrated circuits and out-sources most or if not all of the required manufacturing and testing operations. Fab-less businesses 10 typically have relatively low start-up costs, indicating a relatively low barrier to entry of this particular market segment, resulting in an almost geometric increase in the number of fab-less semi-conductor companies 10 over the past 10-15 years. Fab-less companies 10 are technology-driven and highly flexible since they do not have to accommodate large manufacturing plants within their organizational hierarchical structure. Their focus on integrated circuit design and layout technology allows them to bring innovative designs to market much more quickly since they are not under an economic imperative to fill their own wafer fabrication facilities. They may shop for the most appropriate fabs utilizing the most appropriate technology in order to implement their latest design-of-the-moment.

In this regard, a fab-less business 10 moves its final product through a network of either integrated circuit distributors (an IC distribution channel) 12 or directly to Original Equipment Manufacturer (OEM) customers 14, or a combination of the two. In common industry practice, a fab-less design company 10 might employ third party distribution contractors or warehouse and transportation contactors 16 to place their finished product either with a distributor or an OEM, with an OEM, often contracting through an IC distributor for desired product.

Characteristically, an OEM 14 is most often the final consumer and thus exerts a great deal of power and influence over the entire value chain. OEMs 14 are interested in product performance, product quality, and reliability of supply and supply lead times. Because of their power and influence, and OEM 14 is able to dictate conditions to the chain and extract rents/fees in the event that any of its performance metrics is not adequately satisfied. Although they do not exhibit the power and influence of an OEM 14, an IC distributor 12 is similarly interested in dependability of supply, lead times and particularly price.

Integrated circuit wafers are manufactured in specialized wafer fabrication facilities 18. As those skilled in the art will appreciate, wafer fabrication facilities 18 represent an enormous fixed capital investment and are often configured to manufacture integrated circuits of a specific type and technology. Because of their costs, wafer fabrication facilities 18 have very little flexibility to adjust work-in-process and throughput for changing conditions. As will be well understood by those having skill in the art, a wafer fabrication facility 18 should be level loaded at a significant fraction of its rated capacity in order for the facility to be efficient. Fabrication lot size, lot staging and tote throughput capacity must be very carefully planned in order that the manufacturing facilities' effective capacity is maintained.

Once raw integrated circuit wafers are manufactured, the integrated circuits populating the wafers must be tested and the wafers diced into individual chips and the chips packaged into the familiar black, substantially rectangular integrated circuit component products suitable for populating a printed circuit board. Test and assembly contractors 20 perform this function, with most receiving whole integrated circuit wafers as input prior to dicing the wafers, packaging the circuits and testing the final product themselves. It should be noted that some wafer fabrication facilities 18 initially probe and dice their own wafers, shipping only tested good die to a test and assembly contractor 20.

While most test and assembly facilities also represent a large capital investment in machine tooling, testers, robotic handlers and environmental conditioning equipment, they have a great deal more labor flexibility than a wafer fabrication facility. Nevertheless, since test and assembly facilities represent a large capital investment, test and assembly facilities must also run at a significant fraction of their rated capacity in order to be efficient and profitable. Thus, it will be understood that the constraints under which a wafer fabrication facility and test and assembly facility must operate place a premium on reliability and stability of workflow.

The typical wafer fabrication has a portion of its capacity allocated to major semi-conductor manufacturers, with another portion perhaps allocated directly to an OEM 14 and the remaining portion to a fab-less companies 10. Consideration such as wafer diameter and design compatibility, product qualification and technology compatibility, compound the rigidity of this particular segment of the supply chain. This rigidity consequently leads to the necessity of supply contract with allocated capacity. A fab-less company 10 must spend a great deal of attention on balancing its demand against the available or allocated supply from its wafer fabrication partners. Yield issues, new product introduction, and variable costs complicate the supply and demand issues, particularly where it is understood that it typically costs approximately $500,000 to qualify an alternative wafer fabrication facility as a second-source. Thus, capacity allocation, capacity contracts and capacity collaboration are key processes that need to be addressed in the exemplary value chain of FIG. 1.

Similarly, a demand change that might be considered small for an OEM 14 might represent a large wafer re-start requirement in a wafer fabrication facility 18, due to low yields in any part of a supply chain or a particularly tight performance demand. Test times at the test and assembly facility 20 can often represent a critical portion of the planning for this part of the supply change. A few milliseconds added to the test time for a single integrated circuit may result in a supply constraint that is unacceptable for the demand, when it is understood that hundreds of thousands of integrated circuits must be tested. Thus, supply collaboration and alternate sourcing avenues represent key processes to be addressed in that situation.

Further, when a printed circuit board sub-assembly or other special packaging is required, a sub-assembly contractor 22 is typically utilized. A sub-assembly typically requires test and burn-in capacity and the supply chain issues here can be characterized as test times in capacity, burn-in capacity and cost. In certain situations, if a specialized package is required, special connectors or other component supplies may become issues for the sub-assembly contractor 22 and, consequently, for the fab-less nexus.

It can be understood from the foregoing discussion that the integrated circuit industry value chain comprises a large number of components and touch points. The product chain, from foundry to final user is highly fragmented and the contemporary trend is toward further dis-integration and fragmentation for higher flexibility. A typical integrated circuit chip changes its location from between three to about eight times and might travel between 5,000 to 25,000 miles from initial design to final assembly. The total manufacturing cycle ranges from about 30 to about 75 days and numerous product yield uncertainties lead to re-starts and re-works which may further complicate relationships across partners. Thus, as will be understood by those having skill in the art, the supply chain of this industry can be seen as being very complex and relying on sophisticated physical processes. Most of the component organizations of the integrated circuit supply chain have relatively low competencies in operations excellence, since most are small and have low economic power compared to the wafer fabrication foundry at the back end and an OEM at the front end (their suppliers and buyers).

FIG. 2 illustrates a simplified, semi-schematic flow diagram of a conventional solution environment that may be utilized in connection with an integrated circuit supply chain exemplified in FIG. 1. As was true in the product chain illustrated in FIG. 1, the fab-less company 10 is the central nexus of the conventional solution environment, with product flow defined by fab-less master planning 30. Master planning 30 receives capacity allocations and product mix targets from a capacity planning function 32, which in turn receives unconstrained forecasts from a demand planning organization 34. Demand planning 34 is performed in accordance with raw forecast data and collaborative forecast information received from an entity's customers, such as an OEM 36. Collaborative forecast information is often derived through collaboration with an entity's demand fulfillment organization 38 which is concerned with product shipments, order fulfillment, and the like. Based on actual product delivered, an OEM is able to adjust its intermediate term demand and make such adjusted information available to an entity's demand planning organization 34.

Based upon perceived demand, unconstrained forecasts are provided to capacity planning 32 which determines capacity allocations and product mix targets. An order management system 40 collects information relating to promised orders, backlogged orders, and the like, and provides this information to master planning 30 where it is used to inform and adjust capacity allocation and product mix target decisions. The master planning communicates the capacity allocations and product mix target decisions to the wafer planning function 42, and orders are placed with a wafer fabrication foundry 44 and with an assembly and test facility 46, each of which have their own planning solution environment that may, but more likely may not, be similar to the environment experienced by the fab-less business.

The various production planning processes, utilized by any one of the component elements of a supply chain, are hosted on generally antiquated, purpose-built systems, that execute periodically (and typically in batch mode) to understand requirements to meet new demand. Batch runs are typically executed sequentially by all of the partners in the supply chain in to understand the chain's ability to satisfy unforeseen demand spikes or customer quote requests. Because of the disjoint nature of the chain, and the limitations associated with conventional production planning processes, dynamic changes of supply or demand in the system are difficult even to recognize, much less capture with any degree of efficiency. Information turn-around time is often several weeks in length, resulting in extremely limited visibility into changes in the supply chain. Demand, work-in-process, inventory or capacity information for various factories in the supply chain may reside in different systems that are implemented in multiple sites across the supply chain. It is very time-consuming to try to coordinate and consolidate needed information, particularly where spreadsheet-based applications are the primary planning tool. This manual manipulation of data in to make planning decisions results in slowed response and sub-optimal decisions-making processes. Further, it may be impossible to take into account all of the constraints and trade-off in such manually manipulated systems. Accordingly, problems are often recognized too late, causing excessive expediting, fire fighting and frustration levels.

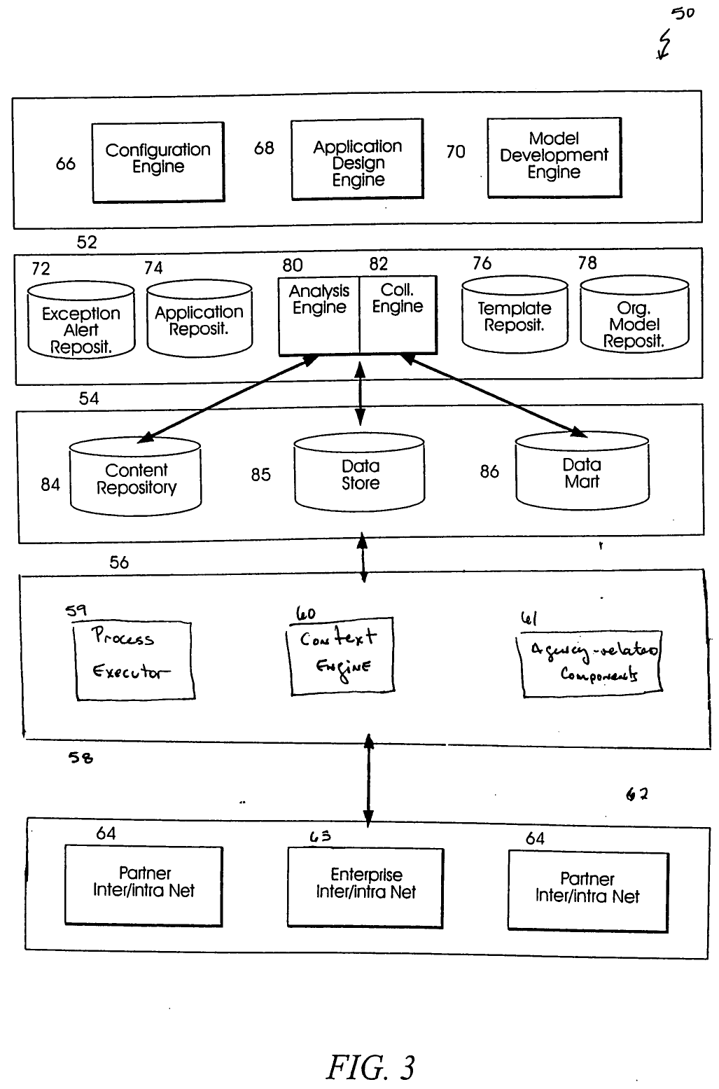

FIG. 3 shows an exemplary embodiment of a solution platform in a simplified, semi-schematic form. In the illustrated embodiment, a solution platform 50 may comprise a five-layer structure having a user interface portion 52 and infrastructure portion 54 and a data store portion 56 functionally layered to host the inventive system, an agency portion 58, and a backend system 62. Those skilled in the art will appreciate the decision support system disclosed herein may be configured to functionally operate within an solution platform 50 having any number of layers, thereby providing a scalable and tailorable system.

As shown, the user interface portion 52 includes a configuration engine 66 which functions in conjunction with an application designer 68 to configure various solution applications to the specific needs of a defined supply chain, in a manner to be described in greater detail below. The application designer 68 serves as a development tool kit that allows an application designer to develop workflow management applications such as distribution planning, demand management, procurement and sourcing, inventory planning and performance analysis in accordance with enterprise workflow requirements and component organizational models. Further, the interface portion 52 includes an organizational modeling engine 70 which provides an organizational model overlay to the application design engine 68 which allows solution applications to be generated and configured in a manner defined by a given organizational structure.

The infrastructure portion 54 is suitably comprised of a number of repositories, including an exceptions/alerts repository 72, an application repository 74, a template repository 76 and an organizational model repository 78. These repositories contain information, key decision parameters and measurement metrics that are utilized by an analysis engine 80 operating in conjunction with a collaboration engine 82 to generate the activity requirements and decision action points necessary for planning and allocating decisions, particularly dynamically changing planning and allocation decisions, throughout the entire value chain. The analysis engine 80 and collaboration engine 82 extract content from, and provide modified content to a content repository 84, the data store 85, and data mart 86, of the data store portion 56 where information is available, through the system's agency portion 58 to all participants in the enterprise, in a manner and form which is particularly suited to their own specific organizational structure and requirements.

As stated above, communication and information integration is performed by an agency portion 58, in turn comprising a process executor 59, context engine 60, and agency-related components and servelets 61, by which a business process is scheduled to be run by the process executor 59 and is able to share content for global exchange between and among the enterprise system 63 and chosen parties (or all) of the partner systems 64. The system communicates with an enterprise-wide array of backend systems 62, suitably comprising an enterprise-wide infrastructure network 63 and various partner systems 64. All backend systems 62 intercommunicate with each other and with the solution platform 50 through XML scripted application files communicated over a wide area network, such as the internet.

It should be noted at this juncture that dynamic management is performed on an exception basis, after a generalized master planning procedure has been completed. Necessarily, the master planning procedure will be performed in accordance with defined applications configured in accordance with each participant's organizational hierarchy and structure, such that even the master planning cycle is performed on a collaborative basis. Information is readily available to each of the participants through a wide area network and the appropriate forms, reports, orders, allocations, and the like, are directed to the specific affected parties, on a dynamic basis, to thereby enable suppliers, manufactures, distributors and retailers to collaborate, integrate and synchronize their planning and fulfillment obligations.

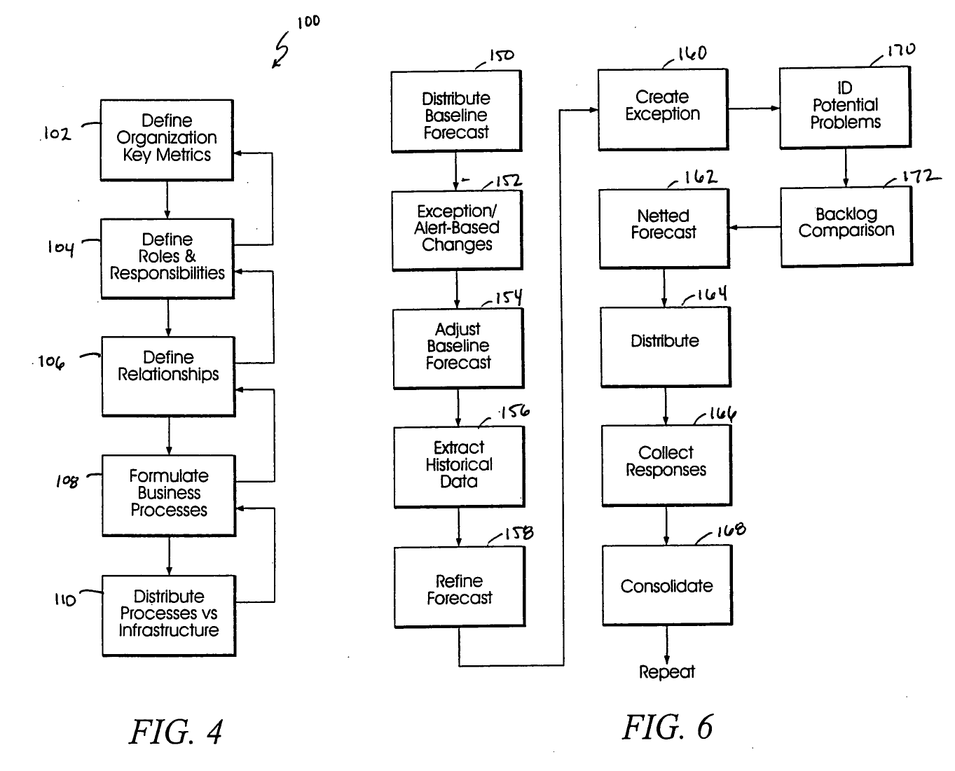

In accordance with the invention, solutions hosted on the solution platform depicted in the exemplary embodiment of FIG. 3, are organizationally driven and implemented in a top-down scalable methodology, as illustrated in the exemplary business process engineering flow diagram of FIG. 4. As shown in FIG. 4, the business process engineering methodology 100 is initiated by defining an organizational structure for each of the participants and associating a set of key metrics, step 102, with each of the nodes of the organizational structure. Organizational definition may be defined with respect to multiple responsibility domains. For example, organization might have a conventional organizational reporting hierarchy, where engineers report to supervisors, supervisors report to managers, managers report to vice presidents who in turn, report to a president. Further, organizations might be constructed in terms of a product hierarchy which is further subdivided in terms of various distinct product lines, themselves subdivided into product categories, groups and eventually individual products or parts. Organizations might also be subdivided geographically, as where sales or marketing organizations might have various areas of responsibility such as a hemisphere, country, state or individual store location, for example. Often, organizations are comprised of a combination of hierarchies with management, product and geographic hierarchies often juxtaposed with one another.

As illustrated in FIG. 4, the definition of organizational key metrics, step 102, results in the definition of roles and responsibilities, step 104, for each of the nodes identified in the organization model. These roles and responsibilities, step 104, might be as simple as defining a particular engineering function for a design engineer, for example, or might be as complex as the multi-dimensional responsibility of a major accounts manager or a wafer fabrication capacity planner. However simple or complex the roles and responsibilities, step 104, identified to each node of the organizational structure, it is sufficient that each of the nodes does indeed have a defined role and/or responsibility, such that the system may be transformed from a title-based approach to a role-based approach, with the necessary context identifier being made internally.

Once roles and responsibilities, step 104, are established, relationships between those roles are established, step 106, in a manner consistent with the role's functional definition. For example, an individual having an order entry role and responsibility for collecting order information from an entity's customers would necessarily have an identified relationship with a customer's planning and/or purchasing personnel. Conversely, an order entry individual would not necessarily be expected to have or maintain a relationship with a design or test engineer, thereby obviating the need for a need for coupling at that level of granularity.

Given a set of roles and responsibilities, step 104, identified to any particular node of the organizational structure, individuals with similar (more properly complimentary) roles and responsibilities can be identified to one another through those roles and responsibilities, as opposed to merely by their functional organizational title. The relationships, step 106, between entities are defined by the similar or complimentary nature of the roles and responsibilities of the identified organizational nodes of the organizations that structure each entity.

Once the relationships, step 106, are defined, a business process is formulated, step 108, to structure each relationship in a rational manner. Each business process is informed such that the roles and responsibilities of the nodes comprising the relationship are efficiently satisfied. Necessarily, performance characteristics and measurement metrics are defined for each of the identified roles, in order to insure that the relationship transaction is maintained effectively on a long-term basis. Each business process is able to acquire and maintain performance statistics by measuring each transaction against the defined set of parameters and measurement metrics.

Thus, a sales organization (role) and indeed individuals within the sales organization, might be measured on the basis of performance to quota, sales to a desired product mix, sales to a target customer base, dollar volume, profit, and the like. Certain of these performance metrics are also very useful in defining internal relationships between a sales organization and a product planning department or a design engineering department. For example, a new design must often enter the marketplace quickly in order to recapture a large initial investment in engineering resources and tooling. Accordingly, a marketing/sales department must have accurate and timely information on the availability of new product such that it is able to focus its attention on obtaining design-ins for the new product throughout its customer base. Necessarily, its historical activity and success rate in such endeavors will have a great bearing on management's confidence in expending the resources in order to develop the new product. Further, marketing/sales needs to be judged on its ability to market and sell the new product. Collaboration, in this regard, involves a multi-level business process that is driven by a time-variable set of roles and responsibilities defining the relationships between designers, marketers and customers.

In view of the foregoing, it would appear evident that business processes generated in accordance with a set of defined relationships would be sufficient. However, true efficiency and inter and intra enterprise collaboration are enabled by distributing the formulated business processes, step 110, on an enterprise infrastructure basis, thereby enabling multiplicities of organizational hierarchical structures to obtain each of a value chain's component entities. When business processes are distributed, step 110, in accordance with an enterprise infrastructure, each of those processes may be individually tailored to meet the specific needs of an organization at either end of the relationship connection.

If, for example, the primary responsibility for production testing throughput was allocated to an individual at a relatively lower level of a managerial hierarchy, but that individual establishes a responsibility relationship with a mid or high level individual at an up-stream or down-stream link of the chain, the associated business process is adaptively informed so as to provide the lower level individual with the types and forms (content) of information necessary to be reported to that individual's own higher level management in order to fulfill their roles and responsibilities (business processes). Thus, it should be understood that any particular business process is a function not only of the relationship defined by complimentary roles and responsibilities, but also of the relationships defined by the individual organizational nodes that comprise the transactional link. In relational terms, a business process must be able to adapt to a many-to-one, one-to-one, and one-to-many scenarios, each with their own particular role, responsibility and relationship metrics.

Organizing the methodology in this manner allows for the overall solution to meet the two challenges of a distributed business enterprise, such as an industry value or supply chain. The solution allows management of the internal complexity of each part of a virtual supply chain, including production planning and scheduling, shop floor control and transaction management by utilizing the various conventional applications that are currently performing such tasks, but implementing those applications in a manner that conforms with the business's organizational structure. In addition, the external complexity, across the virtual supply chain, is managed collaboratively via an exception basis, and includes management of such functions as collaborative demand planning, collaborative operations planning, exception based demand and supply match, and performance management and analysis. As such, the key concepts associated with the methodology of the invention include modeling the organizational structure of an atomized value chain which provides the flexibility to implement incrementally and organizationally efficient processes to manage demand, capacity, supply and inventory on an exception basis. The system allows role based global and local visibility of key interaction points allowing for role based and organizationally logical decision support methodologies. A business is tracked and monitored by exception and at multiple levels of granularity, which are vertically coordinated in accordance with an organizational hierarchy. The system infrastructure allows for inter- and intra-organizational modeling of people, information and processes. Best practices and template formulation, at the organizational level, focus on the quality of the process first which leads to more efficient and cost-effective results.

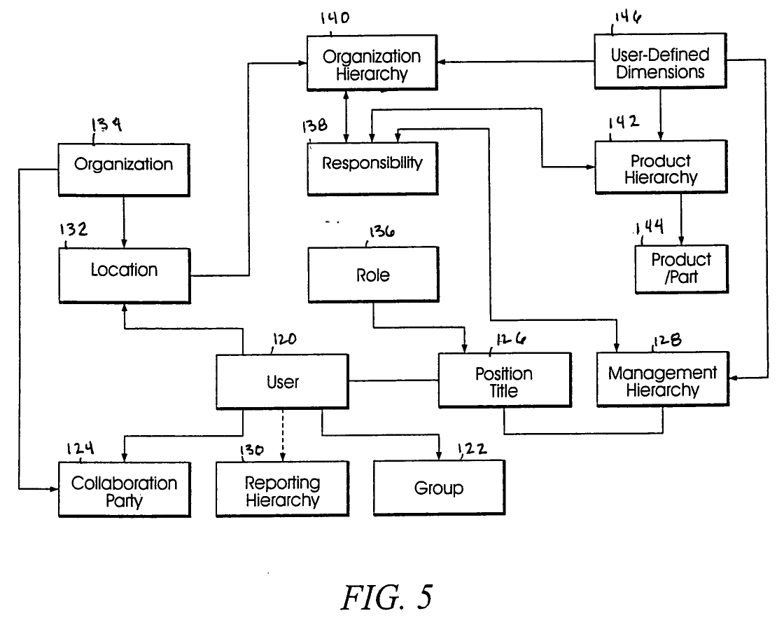

FIG. 5 shows an exemplary organizational model depicted in simplified, semi-schematic form and illustrates some, but certainly not all, of the various dimensions that might encompass an organizational model of a particular value chain. As shown, a system user 120 forms a convenient starting point for traversing the exemplary organizational model. A system user, for example, might belong to one of many different pre-defined groups 122, with each group 122 perhaps comprising some subset of a product category, engineering functional group, managerial group, or the like. Thus, the user 120 may belong to a group 122 and also belong to one of many different collaboration parties 124. Collaboration parties 124, in this context, are defined as a linked association of users that have some logical relationship to one another through a role or responsibility, as defined by the organizational model, and as will be described in greater detail below.

In addition to belonging to a group 122 and collaboration party 124, a user 120 might be identified by a position title 126 which, in turn, relates to a particular position within a management hierarchy 128. Position titles 126 and management hierarchies 128 reflect an organization's formal organizational chart which may, or may not, correspond to an actual reporting hierarchy 130 for the individuals comprising the organizational chart. In many cases, reporting hierarchies 130 are a bit different from management hierarchies 128, since certain individuals might collectively be formed into “tiger teams” or other, ad hoc functional groups for executing a solution to a particular problem or project. Accordingly, a user 120 might also come under a reporting hierarchy 130 in addition to having a position title 126 that reflects their position within a management hierarchy 128.

Further, each user 120 might be situated at one of many different locations 132, each of which may include a multiplicity of internal organizations 134 that are linked to and collaborate with the user 120 through the user's collaboration party 124. Locations 132, along with their attendant organizations 134, might be exemplified by various design facilities that are separated from one another in space (in separate buildings or even in separate cities) or which might be separated from one another by functional distribution throughout a campus (a CMOS design group in one area and an analog design group in another). Various planners and design and production managers in each of these organizations must collaborate with one another, since they very likely share certain central facilities within the business. For example, analog and CMOS designers often use a central layout and mass manufacturing facility, as well as sharing testing and “debugging” laboratories. All of these facilities need to be collaboratively scheduled in order to ensure efficient process flow and each are necessarily run by their own organizations.

Referring again to FIG. 5, a user's position title 126 within a management hierarchy 128 implies a number of roles 136 by virtue of the position. Likewise, each slot of a management hierarchy 128 is linked to a dimension of responsibility 138. Likewise, each location 132 belongs to an organizational hierarchy 140, which is also linked to a dimension of responsibility 138. Thus, following our discussion above, a CMOS design manager (a portion of a management hierarchy) fits into an organization hierarchy 140 as an individual having responsibility for successful designs of CMOS products. The CMOS design manager will have an organizational responsibility for successful product implementation, as well as a management responsibility for both overseeing their staff as well as reporting to their superiors in the reporting hierarchy 130.

Further, since the CMOS design manager is concerned with CMOS products, their dimension of responsibility 138 is also assigned to a product hierarchy 142, which, in this exemplary situation relates to CMOS products. Where additional levels of granularity are desired, various individual products or parts 144 are assigned as belonging to particular portions of a product hierarchy 142. An example of this level of granularity might be the differentiation between CMOS telecommunications products and/or CMOS microprocessors.

Necessarily, and in accordance with principles of the invention, user defined dimensions 146 are used as the primary formation of the organization hierarchy 140, product hierarchy 142 and management hierarchy 128. These user defined dimensions 146 operate to inform the organizational model with the particular structure of the particular business or facility, which is being modeled. Once the organizational hierarchy, management hierarchy and product hierarchy are defined, position titles 126 may be assigned as belonging to the management hierarchy 128 and product and/or part numbers 144 assigned as belonging to the product hierarchy 142. The organizational hierarchy 140 is functional in nature and, as such, has its component parts directly linked to a dimension of responsibility, as are the component parts of the product hierarchy 142 and management hierarchy 128. The organizational hierarchy 140, product hierarchy 144, and management hierarchy 128 are linked through the user defined dimensions 146, such that any particular user 120, having a position title 126, is able to identify their role 136 as it is expressed through the management hierarchy 128 and to reflect that role to a position within the product hierarchy 144 and to eventually identify their dimension of responsibility associated with their role. Similarly, the user 120 is established at a location 132, which belongs to an organizational hierarchy 140 and is thereby linked to a further dimension of responsibility for that user's role 136.

The many organizations 134 that can be defined through the organizational model of FIG. 5 are able to collaborate with one another by each organization's definition of collaboration parties 124 which can be viewed as associations of users with either similar or complementary sets of roles and responsibilities. To amplify our previous discussion, the manager of a “mask” shop will have a set of responsibilities (when viewed in terms of the organizational hierarchy) with the CMOS design manager. The CMOS design manager must ensure an orderly work flow into the “mask” shop, while the shop manager must schedule adequate and appropriate time for CMOS work, while accommodating perhaps other CMOS product groups, as well as potentially an analog work group, and the like.

Where specific individuals (users) are identified as sourcing work requests for layout designers and mask fabrication, that user's roles and responsibilities are adaptively informed by their repositioning under a reporting hierarchy 140, regardless of their position title 126 and placement within the management hierarchy 128. Thus, various identified engineers from various CMOS working groups, as well as analog working groups, may collaborate during the layout design and mask fabrication steps in order that each working group's schedules are accommodated in an efficient and timely manner.

Those having skill in the art will understand that the various users defined dimensions 146 are an important facet of the definition of an organizational model in accordance with the invention. Care must be taken to understand and accurately portray each organization's management hierarchy 128, product hierarchy 144 and organizational hierarchy 140.

Structuring the system in this manner allows for the novel methodology to support service oriented solutions in implementing any business process. Such service oriented solutions include collaborative net change demand forecasting and planning, collaborative net change supply match demand planning, collaborative and exception based order tracking and execution, as well as collaborative supply and capacity allocation. In the context of demand management, the system provides a framework for collaboration between planning, sales, marketing, finance and logistics within a company (all identified elements within an organizational hierarchy and each having a role and responsibility) and with customers and sales partners outside the organization. While each business function (organizational model node) develops its own projections for market demand and customer needs, all of the business functions will be able to reach a consensus through the collaboration party function. Thus, a business's investments in statistical forecasting tools may be combined with the power of the novel collaborative forecast process in order to develop and manage not only product and work flow, but also a financial budget to support sales and marketing activities.

Further, demand management analysis allows the measurement and tracking of business performance across various different business units. Demand management analysis is a collaborative business intelligence tool that trades information across a company intranet or, between a company and its partners over a wide area network such as the Internet. Business performance may be measured and emerging trends discovered in each market segment, by analysis of historical data. Since the system contemplates point-of-sale feed, in real-time, a user is able to measure current performance of the business as opposed to making present inferences from past performance.

FIG. 6 shows an embodiment of a collaborative forecasting flow diagram, suitable for use in connection with collaborative forecasting in connection with the methodology of the decision support system. In the context of collaborative forecasting, the novel methodology contemplates use of existing demand planning systems, utilizing a wide array of inventory management strategies. For example, the novel methodology is particularly suitable for use in connection make-to-order, Kanban, and fixed-rate supply strategies, as well as a wide array of inventory replenishment strategies which might include materials requirements planning (MRP), manufacturing resources planning, distribution requirements planning (DRP), just-in-time production (JIT), supplier-managed inventory, consignment, statistical inventory control, and time-phased reorder point. These strategies are well known to those skilled in the art and will not be extensively discussed herein. All that is required is that some methodology for forecasting and planning be implemented, with the software hooks and reporting distribution being made to an organization on the basis of its organizational model.

In the collaborative process, a baseline forecast is distributed by the appropriate distribution entity to the business's distributors, sales organizations and potentially OEMs for review and adjustment, step 150. The sales force and OEMs communicate forecast and order changes in accordance with an exception and alert process, step 152, to be described in greater detail below. Thus, the baseline forecast is adjusted on a collaborative basis, with all effected parties establishing their inputs in an efficient manner, step 154. Necessarily, baseline information is passed to those individuals within the different organizations that have the identified role and responsibility for adaptively modifying the forecast in order to make it appropriate for their organization.

In the context of the exemplary flow diagram of FIG. 6, the adjusted baseline forecast is refined, step 158, by the initiating entity based on historical forecast and performance data which has been acquired and stored in the system's data store, step 154. Each organization will necessarily develop and maintain their own data store, containing content and statistical analysis tools suitable for their specific organization's needs. Once the refined forecast is completed, step 158, exceptions are created for potential problems, step 160, which might have been developed by comparison of the refined forecast data with backlog information, for example. This is similar to generating a replenishment forecast or netted forecast, step 162, in contemporary jargon. As shown, potential problems are identified, step 170, and a backlog comparison 172 may performed prior to or concurrent with the generation of a netted forecast.

Exceptions (either exception data or alerts) are distributed across the entire virtual supply chain, either by “pushing” an exception report to identified responsibility partners, through use of an “agent” or “bot,” as will be understood by those having skill in the art, step 164. Alternatively, exceptions might reside in a centralized data store whence they are accessible to all role/responsibility partners and from where they might be retrieved over an intranet or the Internet upon receipt of an “alert.”

Responses to the generated exceptions are collected, step 166, by the issuing party and consolidated, with the refinement and exception creation processes repeated on an ongoing basis, such that the process is dynamic and constantly responsive to exception alerts issued by any entity within a collaboration party. Further, the entire process, from the point of baseline forecast preparation, is repeated on a periodic basis, with the periodicity being that chosen among the collaboration group for a forecasting cycle. Baseline forecasts may be made weekly, monthly, quarterly, or annually, depending upon the particular needs and desires of the value chain. Thus, the novel methodology is able to conform to standard industry cycle times, as well as for providing a methodology for dynamically modifying and updating planning and performance data within the periodicity of a chosen cycle time.

In the context of backlog and order exception management, order changes, which might occur as a result of various economic indicators or factors which might effect any one of the entities within a value change, are created and distributed across the collaborative intra- and inter-network for immediate collaborative resolution. Change order requirements occur as an “exception alert” to the baseline forecast and are necessarily visible to all partners within a collaborative party. For example, a sudden reduction in the availability of a particular integrated circuit package will impact the availability of all integrated circuit products offered in that package. The issue is now not only between an integrated circuit assembly facility and its suppliers, but also becomes an issue for the IC design house, its distributors, transporters, OEMs, and other customers in the chain. Product availability changes initiated as an “exception alert” by the assembly facility will now be apparent to all collaborators on an immediate basis, making for greater opportunities for innovative solutions. Such a supply alert can have a significant impact on the entire wafer fabrication, product assembly, and product test and distribution chain. Collaboration, in accordance with the methodology of the present invention, allows creation of a plan versus plan supply alert to be communicated for either internal resolution, external notifications, or both.

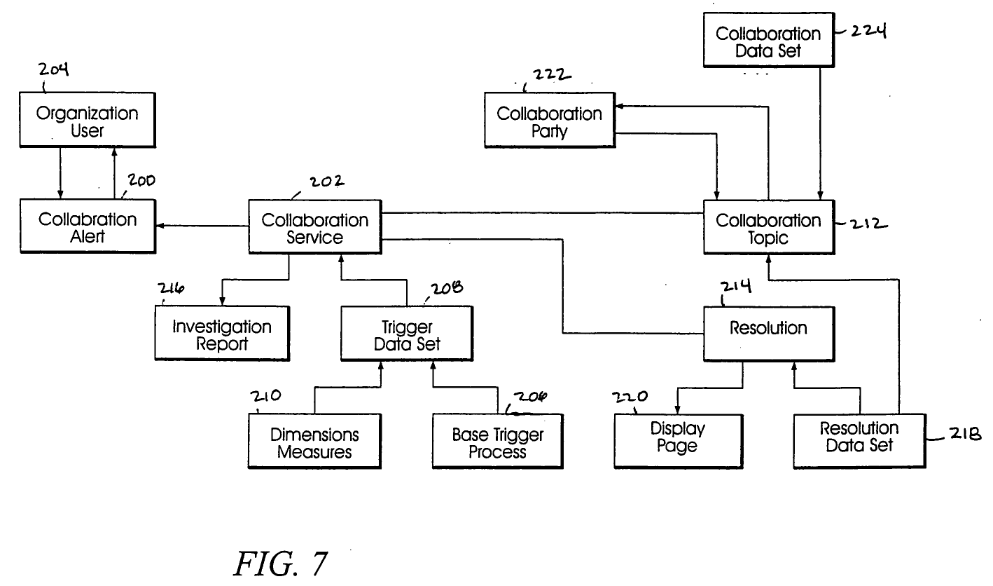

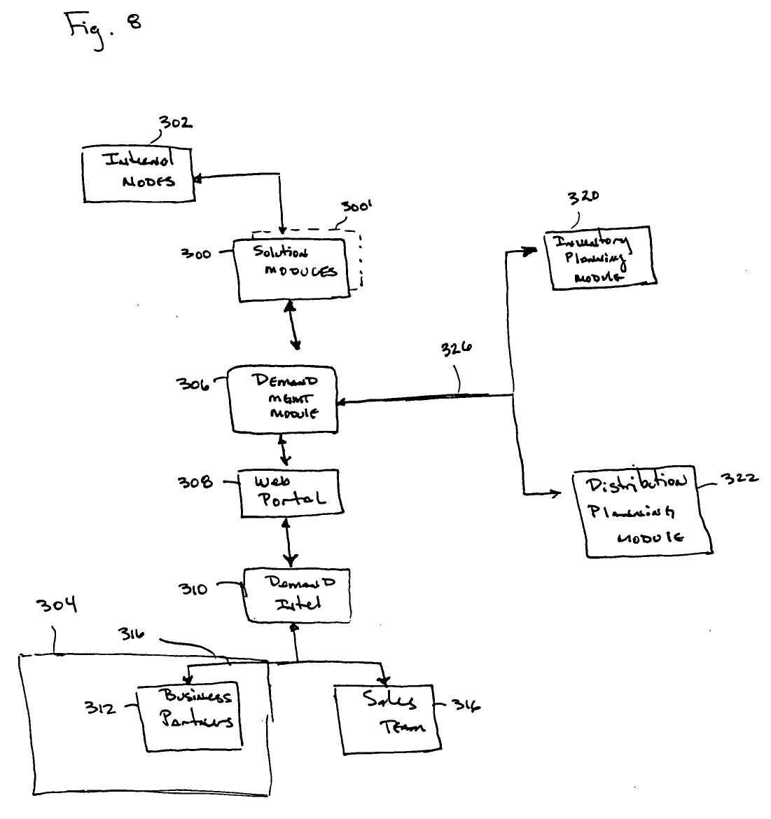

FIG. 7 illustrates an exemplary embodiment of an exception management model in simplified, semi-schematic form. As shown, a collaboration alert 200 is configured for a collaboration service 202 which operates as a software configured application routine that services the various members of a collaboration party 222 in the event of a collaboration alert 200. Collaboration alerts 200 are configured by organizational users 204, which configure collaboration alerts 200 in accordance with the particular needs and desires of a particular collaboration party 222. Collaboration alerts 200 might be served upon occurrence of a product change order, product quantity change order, or any other exception based phenomenon, which impacts a particular plan or forecast. Depending upon their roles and responsibilities within an organizational hierarchy, product hierarchy or management hierarchy, an organization user 204 subscribes to one or many collaboration alerts 200, depending, once again, on their defined roles and responsibilities within the organizational model.

A collaboration based trigger process 206 defines a trigger data set 208, which, in turn, invokes the collaboration service 202. The trigger data set 208 is informed by a set of dimensions and measures 210, which set the threshold for the trigger data set 208. A collaboration based trigger process 206 might be exemplified by a particular inventory level, with the trigger data set 208 defined by a particular value of product contained within either a warehouse or pipeline. Dimensions and measures 210 set desired inventory levels, for example, against which inventory levels are evaluated and against which a threshold is set for the data trigger. Once the trigger data set 208 is reached, the collaboration service 202 issues a collaboration alert 200 to all organizational users 204 subscribed to that alert informing them of (in this case) abnormally high or abnormally low inventory levels for a particular product.

In this regard, a particular collaboration service 202 might define a number of collaboration topics 212, as well as a number of resolution sets 214 for the identified problem. Additionally, and depending on the collaboration based trigger process, a collaboration service 202 might further include a number of investigation report forms 216 that are distributed to the subscribers in order to obtain additional data that might lead to a more effective resolution.

Each defined resolution 214 typically includes a resolution data set 218 that defines the outcome of the issue. A resolution display page 220 displays issue resolution 214 in a manner that all parties to the transaction are able to view and comment on. Each resolution data set 218 maps to a collaboration topic 212. For each specific issue in the process, a collaboration topic 212 will typically comprise an initiator and a responder chosen from the collaboration party 222, which makes up the decision pool. For each topic, a collaboration data set 224 is generated that, along with the resolution data set 218 is stored and maintained in the data store such that a historical record of issues and resolutions are available for subsequent analysis in case of future need.

As was the case with the organizational model discussed in connection with the embodiment illustrated in FIG. 5, the exception management model requires a certain degree of care in definition of the collaboration based trigger processes 206, as well as the dimensions and measures 210 which define the trigger data set 208. Each of the collaboration based trigger processes 206 may be well defined and adequately and accurately tagged to collaboration parties to ensure that the issue/resolution process is focused on the particular issue at hand and that the details of the process do not become burdened with extraneous factors. It should be well within the understanding of one having skill in the art, how the exception management model, exemplified in FIG. 7, is eminently suitable for supporting a collaborative capacity management, demand management or supply management operation, where collaborative baseline forecasts define the process fundamentals, and all adaptations, modifications, or the like are handled on an exception basis, by appropriate parties (collaboration parties) identified in terms of their roles and responsibilities within a functional organizational model.

In this regard, the novel methodology is equipped to develop and maintain a set of key performance measurements and metrics, as a consequence of the ongoing exception management process. All of the information contained within a collaboration data set (224 of FIG. 7) and the resolution data set (218 of FIG. 7) are available for statistical analysis and historical record keeping. Accordingly, because of the wealth of information, and its fine-grained detail, the novel methodology allows for inventory planners to more efficiently decide the optimal balance between safety stock and customer service level, for each classification of products and market segment. Optimization is time-phased and may be conducted at each stocking point in the distribution network, considering the desired level of service, demand, supply variability and lead times; all of which are adaptively informed by exception-based planning and forecast management. Inventory planning can be deployed to implement distribution resource planning (DRP), vendor managed inventory (VMI), efficient customer response (ECR), or just-in-time (JIT) inventory management techniques through balancing fiscal objectives and customer service priorities. Further, inventory planning, in accordance with the invention, enhances collaboration at every level of the business process. Necessarily, inventory planning is a critical component to any collaborative replenishment strategy, such as CPFR, a methodology which is particularly suited to practice in the present invention.

In addition to inventory planning, distribution planning optimizes the distribution network and creates a replenishment plan. Distribution planning is a constraint-based planning solution for managing the complexities of a supply chain, utilizing an aggregated model of the supply chain to recommend decisions about what to procure and distribute that is executed across manufacturing and distribution facilities, transportation networks, and supplier and customer connections. By balancing and synchronizing operations throughout the enterprise, distribution planning enables consistent attainment of demand and supply imperatives, thereby maximizing the performance of the supply chain. In the context of the invention, replenishment planning is exception driven, enabling planners to focus only on those situations where supply and demand are out of balance. Consequently, planners are able to spend their time making informed decisions about resource allocations, order expediting and customer service, without expending substantial resources on problems such as stockouts and outdated inventory.

In this regard, it should be noted that the exception management model is suitable for deployment across an organization's financial arms, as well as product design, manufacture and distribution. Financial planning activities have the same importance as work and product flow plans and are subject to the same imperatives which define manufacturing and marketing based business practices. Financial planning also implies a baseline forecasting activity that overlays and interplays with manufacturing and sales processes. Price, costs and margins often play as important a part in a business process decision as such considerations as product availability and inventory levels. Often, an effective business decision will be made on the basis of a profit margin difference between two alternative solutions, with the higher profits margin resolution necessarily suggesting the more rational course of action.

As financial data is integrated into the system, planners are able to base their decisions not only on simple mechanical or structural constraints (i.e., the availability of one product or another), but also on the financial impact of their alternative choices and/or decisions. Historical trends that superpose a baseline forecast might give an indication that a particular product, product line or even product category is reaching a terminal stage in its lifecycle. Availability of financial data to a product planner will allow the product planner to make end-of-life decisions on a more timely and efficient basis and provide the necessary “exception alerts” to the appropriate collaboration party, such that the entire supply chain is aware of a potential end-of-life situation.

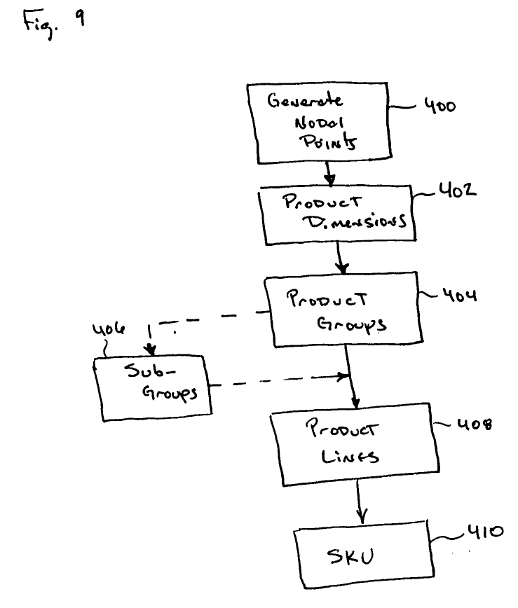

The embodiment of the system 50 depicted in FIG. 3 may host one or more solution modules 300, 300′, each implemented as a software program application, and each hosted in the system's user interface portion (52 of FIG. 3). As shown in FIG. 8, the solution module 300 may include a demand management module 306 which functions as the collaboration glue between the various internal nodes 302 and external nodes 304 of a chain's organizational structure. The demand management module 306 includes or otherwise communicates with a configurable web portal 308 which captures demand intelligence 310 from business partners 312 and the sales team 314 and shares information with them over a wide area network connection 316. This native web-based architecture provides for different levels of partnership between a company and its business partners and can also be configured for different levels of user sophistication based on organizational considerations. Accordingly, forecast accuracy is improved by making the forecast visible over the web to all collaboration partners, thereby enabling collaboration everywhere in the process.

In addition to demand management, the system further includes an inventory planning module 320, which allows business to plan and manage inventory. The inventory planning module 320 might be viewed as an overlay to conventional inventory planning systems, with the module implementing those hooks that allows for module compatibility with the defined organizational model and exception management system. Simulation facilities allow for comparison of both financial and service impacts of any policy changes, as well as for management of safety stock, inventory minimums and maximums, inventory turns, replenishments frequency and order size, seasonal build and manufacturing plans. The inventory planning module thus enhances collaboration at virtually every level of the value chain.

The distribution planning module allows for an enterprise to optimize their distribution network and manage the complexities of the supply chain. The distribution planning module is also exception driven, in that the software application includes the necessary hooks to interface with the exception management system, as well as organizing a functional data collection and presentation in accordance with the defined organizational model. The inventory planning module 320 and distribution planning module 322 may communicate with the demand management module 306 through a wide area network 326. Similarly, the inventory planning module 320 and distribution planning module 322 may communicate with each other through the same wide area network thereby ensuring the demand management module 306 remains apprised of development arising therefrom. In an alternate embodiment, the inventory planning module 320 and distribution planning module 322 may communicate with each other through a devoted network.

In terms of the demand planning methodology, the number of items for which demand planning must be performed often range from a few thousand items, to several hundreds of thousands and, in some cases million of individual products. As a result, there are many users of demand management systems who have responsibility for specific sets of items from a planning perspective. Since demand planning is a collaborative process, there are other users as well who must be involved in the process to collectively evaluate demand. These other users include a large number of different individuals belonging to different functions, regions, and subsidiaries, both within and without the enterprise, depending on the type and form of business organization. This multiple user aspect reflects the fact that the demand planning system implements an organizational model that permits the distribution of the demand planning processes, as well as the consolidation, from various perspectives in the organization.

A collaborative and consensus forecasting will be described in connection with an arbitrarily defined consumer products business. The initial step comprises generation of the nodal points of a corporate (business) organization as shown in FIG. 9, set of product dimensions are created that rationally position products (down to the SKU level) within the structure, step 402. Products might be divided into product groups, step 404, such as “electronics” and “softgoods” categories, with the “electronics” category further subdivided into “VCR”, “TV”, “DVD” and “CamCorder” product groups, step 406. Each product group is also subdivided into product lines, step 408. For example, a product group comprising a listing of VCR devices may be further subdivided by manufacturer, such as Sony and JVC representing subdivisions of the “VCR” product group. Necessarily, each product line may be further subdivided into individual SKUs, step 410, each representing a particular model offered by a manufacturer.

Since businesses are often distributed geographically, a geographic metric is created that structures the business on a geographic scale. This may be done on either a store level, for example, or a point-of-sale level. Geographic structure may view the “world” in terms of countries, states within those countries, regions within a state or country, and by “outlets” within a region. As a result, geographical structures may be expressed in terms of geographical metrics, taking in to account shipping times, availability, etc, in the decision making process.

Evaluating these factors allows creation of an organizational structure by identifying people to organizational nodes. An enterprise will often have a marketing organization with a responsibility scope, which corresponds to the product dimensions. Thus, the business organization is modeled in terms of its product line offerings by individual association. Also, a marketing department is often organized on a geographic basis, as is a consumer product business' operations group (district managers, store managers, department managers and product line managers, for example). Each of these individuals have particular responsibilities within their product line, product group, category, and geographic area.

Once the structural organization is defined, a time dimension is created which sets the planning periodicity, and the basic data measures are defined along with their input (creation) sources. Basic data measures include such factors as sales history (at any level of granularity), store forecast, on-hand inventory, projected inventory, allocated inventory, safety stock, committed forecast and consensus forecast. Necessarily, these data measures are those performance metrics with which any business entity would be most concerned. They will vary from business to business, but will almost always be associated with elements of cost (fixed and/or variable), work-in-process, and profit, appropriate to that enterprise.

Once the organizational and measurement dimensions are created, roles and responsibilities across the dimensions and collaborative relationships are defined. Each of the individuals in the organization should be able to define their collaborative interaction with others in the organization based on their domain of responsibility. For example, a director of a product category, such as VCRs, might have responsibility for VCR products in all geographic areas. Thus this individual “owns” the forecast processes for the VCR product category and, as a result, is responsible for developing a consensus forecast, projected inventory, and allocated inventory. In order to perform these tasks, this individual must collect store forecasts from each store product manager, thereby requiring the “owner” to define a process for collecting each store forecast. By indicating the store forecast as a collaborative decision variable, The system identifies those persons to whom forecast data requests must be made, based on the roles and responsibility relationships established previously.

Based on the defined collaborative relationships, the “owner” of the planning activity formulates the mechanical processes of collecting the forecast. To do so, the “owner” designs a data collection sheet, a process and workflow that determines the activity timing and the manner of collecting the forecast data. A suitable template is designed for this and the template is provided across all potential process “owners” (all product line directors, for example) who are able to customize the format based on their product offering requirements. An exemplary collection sheet design might include a region identification, the name of a store or outlet product manager, a time dimension (an 8 week forecast, for example), a product dimension (i.e., VCR products) the current store forecast and the new store forecast (typically a blank area adapted for collaborative input by the recipient).

The region and name of the store product manager are parameters that will be regenerated at deployment (For all store managers). This means that a product director (owner) designs a template that is instantiated automatically for all store product managers and regions. Based on this template the product manager (owner) defines the collaboration processes; the forecast sheet is sent as a notification to all stores managers, in all regions, requesting them to fill-in the data for their areas of responsibility and submit the completed collection sheet by a given date. Store product managers complete the sheet and submit it.

As the forecast is collected and consolidated in a data mart, the product director (owner) is able to set an exception when, or if, the collected forecast reflects a difference between the collected data and a prior history for any particular store. When the exception is set, the “owner” receives an alert and may return the sheet for confirmation from the store product manager with copies to the store manager. The process continues until every affected individual (everyone with a similar or complimentary responsibility) has completed the form and the results are considered adequate. Then the owner may build a report (A priori) that aggregates the collected data for all regions, on a country basis, and computes the mean for the consensus. The consolidated report might then be forwarded to a country director who might have the responsibility for planning warehouse inventory for that particular country. Based on two planning activities (a calculated plan and a collaborative plan) multiple functionalities allow business users across the organization to perform exception management activities, perform demand data analysis and perform what-if and alternative scenario analysis, as will be seen in an exemplary inventory planning process, below.

Typically, inventory planning workflows tend to be exception based due to the large number of items for which a planner is responsible. In other words, a batch process with minimal human intervention may be used to create the initial inventory plan. Once the plan is determined, exceptions are flagged. Based on the mathematical assumptions used in inventory planning, some exceptions can be determined based on statistical criteria. However, since inventory investment is a significant line item on many financial reports, planners and analysts use a number of business related criteria to signal the existence or potential emergence of a problem. Not all exceptions represent hard constraint violations. Planners use some simply as a tracking device. For all these reasons, the definition of an exception is user-defined. The user drills down from exceptions to specific items that may require attention and attempts to eliminate the cause of the exception.

Since exceptions are user defined, resolving them may involve a very wide range of exceptions. Several parameters related to inventory planning, such as customer service levels, are policy variables. Not only can they be changed if the situation warrants it but their target values can be attained by manipulating other variables. It is up to the planner to determine how to attain this goal. As a result, planners are required to perform a number of what-if analyses and then create plans based on these analyses. For every item (more typically for each defined product group), a user may specify the criteria that determines an exception. For example, the user may specify a formula for critical items that requires an exception to be flagged when the cost basis of recommended safety stock, for example, exceeds $1 million. Another exemplary exception may obtain when the current inventory position is below a certain quantity. Notwithstanding the exception type, a user is prompted by an exception report and traverses the planning workflow. The user navigates to specific exception item (detail) reports in order to determine the nature of the exception and determine a solution to the problem.

In an attempt to diagnose the cause of the problem, the user may view several reports such as an inventory profile report and any other custom reports they may have been defined for either a singular item or a group of items. From any one of those reports, the user may drill down to other reports such as an item properties report which summarizes all the relevant static properties of an item such as the inventory policy used, the calculation mode, and the like. Corrective action for an item may include editing the exception formula, manually overriding planned values, or performing what-if analyses on one or more inventory planning related parameters and taking action based on the most efficacious results.

Necessarily, the system supports the entire inventory planning role. In addition to its exception based decision support, the system is able to perform input analysis, safety stock calculation and sensitivity analysis. These features are also organizationally distributed so as to implement various planning rules while providing the ability to consolidate and aggregate as a part of sales, marketing and operations planning.

Each of the various applications will necessarily vary in their form and content in accordance with the imperatives of the business enterprise with which they are concerned. The operational definitions of demand management, inventory planning, and the like are well understood by those having skill in the art and do not require any further elaboration herein. All that is required is that various operational planning activities, including financial planning activities, be suitably expressed as an executable application and that each application function within an environment defined by a structured organizational hierarchy of the enterprise and, at least, assist in implementing business decision making through exception management of functional and operational planning.

Thus, it will be understood that the systems and methods consistent with practice of the present invention accommodate many special characteristics and requirements of various types of business planning and decision activities. It will be apparent to those having skill in the art that various modifications and substitutions can be made in the definition of the present invention without departing from the scope or spirit of the invention. Other embodiments of the invention will be apparent to those skilled in the art from consideration of the specification and discussion of certain exemplary embodiments contained therein and in connection with the accompanying drawings. Thus, the embodiments discussed and described should be considered as exemplary only, with the true scope and spirit of the invention defined solely by the appended claims.

1. A method optimizing throughout in a supply chain, comprising:
constructing a framework model of the supply chain;
distributing the model through an organization as directed in the model;
incrementally performing product, demand, and inventory management on an exception basis management hierarchy throughout the organization;
monitoring by an exception at multiple levels of granularity activities of the organization; and
adjusting the throughput of the supply chain in response to the exception.

2. A method of managing a supply chain, comprising:
modeling an enterprise organization;
defining key metrics of the supply chain;
identifying roles and responsibilities based on key decision variables and the key metrics;
assigning the roles and responsibilities based on key decision variables and the key metrics;
allocating roles and responsibilities based on identified authority domains; and
defining collaborative relationships required to implement a particular planning process.

3. The method of claim 2 wherein the roles and responsibilities are allocated based on at least of categorization selected from the group consisting of product categorization, geographical location, and organizational categorization.

4. The method of claim 2 wherein the collaboration is defined based on vertical collaboration having managerial to employee relationships.

5. The method of claim 2 wherein the collaboration is defined based on vertical collaboration having peer-to-peer relationships.

6. The method of claim 2 wherein the collaboration is defined based on vertical collaboration having external to internal relationship, wherein an external party interacts with an internal employee.
